(19) United States
(12) Patent Application Publication
(10) Pub. No.: US 2005/0238822 A1
(43) Pub. Date: Oct. 27, 2005

(54) Door-hanging figure

(75) Inventor: Man-Yan Chan, Kowloon (CN)

Correspondence Address: ALIX YALE & RISTAS LLP, 750 MAIN STREET, SUITE 1400, HARTFORD, CT, 06103, US

(73) Assignee: Tapluck Ltd.

(21) Appl. No.: 10/832,072

(22) Filed: Apr. 26, 2004

(51) Int. Cl. G09F 17/00; A47G 33/04

(52) U.S. Cl. 428/7

(57) ABSTRACT

A hanging ornament for attachment to a door includes an upper body part having a support surface for bearing against one face of the door, a lower body part for bearing against the other face of the door. The support surfaces are of the same shape and together define a severance across a torso of a body defined by both body parts when aligned. A strap extends from the upper body part to the lower body part for passing over the door to suspend the body parts at either side in an aligned manner —giving the illusion that the body is passing through the door.

### BACKGROUND OF THE INVENTION

The present invention relates to a door-hanging figure. More particularly, although not exclusively, the invention relates to a “static flying witch” apparently passing as if by magic through a solid door.

### OBJECTS OF THE INVENTION

It is an object of the present invention to provide an entertaining ornament giving the static or “frozen” appearance of something or somebody passing through a solid object such as a door or window.

### DISCLOSURE OF THE INVENTION

There is disclosed herein a hanging ornament for attachment to an opening closure such as a hinged or sliding door or window, the closure having opposed faces, the ornament comprising:

an upper body part including a support surface for bearing against one face of the closure and including peripheral body features including a head extending therefrom,
a lower body part including a support surface for bearing against the other face of the closure and including peripheral body features including feet extending therefrom, wherein the support surfaces are of substantially the same shape and together define a severance across a torso of a body defined by both said body parts when aligned, and
a strap extending from the upper body part to the lower body part for passing over the closure to suspend the body parts at either side in a substantially aligned manner.

Preferably, the support surfaces of the upper and lower body parts are each provided by a base from which a respective skeletal structure extends internally of the body parts, and wherein the strap is attached to each base.

Preferably, the skeletal structure comprises plastics tubing extending from the respective bases.

Preferably, the ornament further comprises wire extending from the plastics tubing into said peripheral features.

Preferably, the ornament further comprises anchor members attached to the plastics tubing and from which the wire extends.

Preferably, the wire defines arms and legs of the respective body parts.

Preferably, the ornaments further comprises padding about the wire and clothing about the padding.

Preferably, the ornaments further comprises hands and feet at respective distal ends of the wire.

Preferably, the clothing of the upper body part comprises sleeves, and wherein the padding is retained within the sleeves by mesh retainers surrounding the wire nearby the hands.

Preferably, the upper and lower body parts together define a witch and further comprising a broom head attached to the plastics tubing of the lower body part.

### BRIEF DESCRIPTION OF THE DRAWINGS

A preferred form of the present invention will now be described by way of example with reference to the accompanying drawings, wherein:

FIG. 1 is a schematic perspective illustration of a door-hanging ornament,

FIG. 2 is a schematic illustration of a door-hanging ornament similar to that of FIG. 1,

FIG. 3 is a schematic perspective illustration of an anchor member and a pair of wires,

FIG. 4 is a schematic perspective illustration of the end of a piece of wire,

FIG. 5 is a schematic perspective illustration of the skeletal structure of the door-hanging ornament of FIG. 2,

FIG. 6 is a schematic perspective illustration of a hand attached to the end of an arm wire, and

FIG. 7 is a schematic perspective illustration of the end of an arm showing a mesh padding retainer.

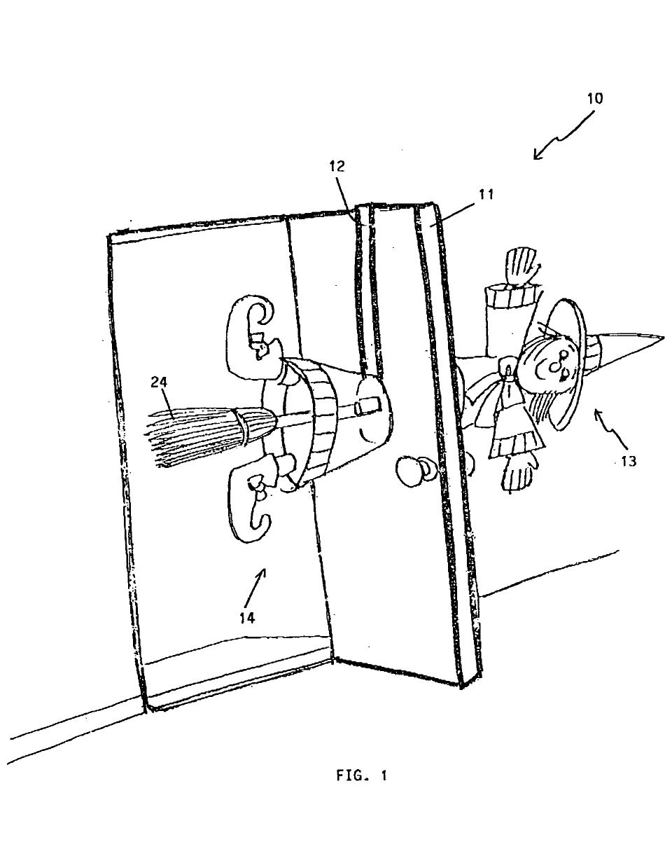

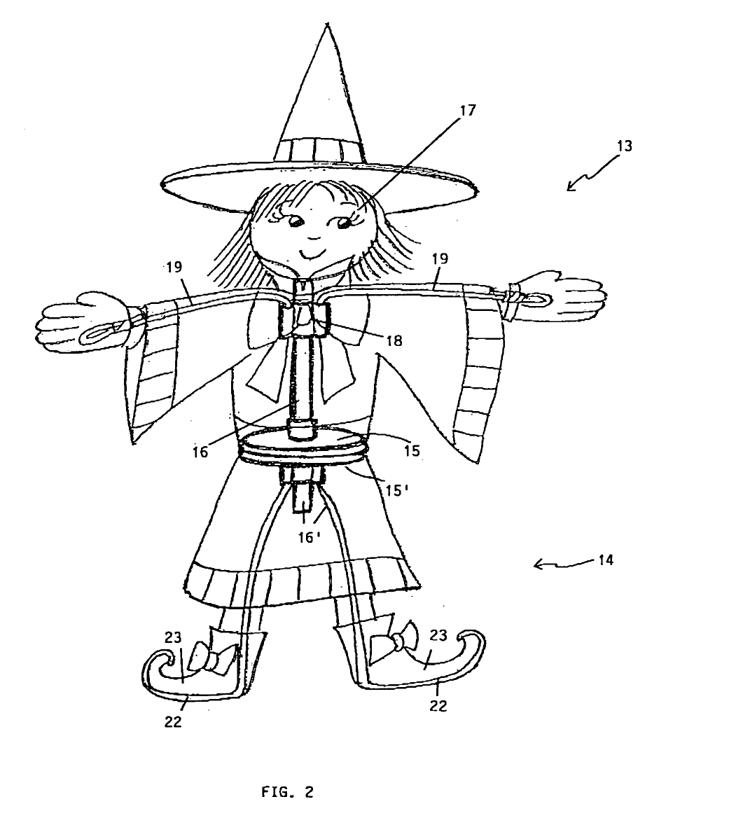

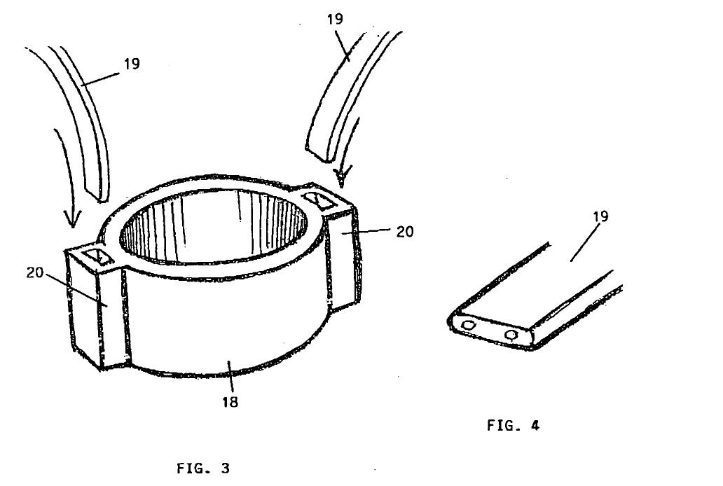

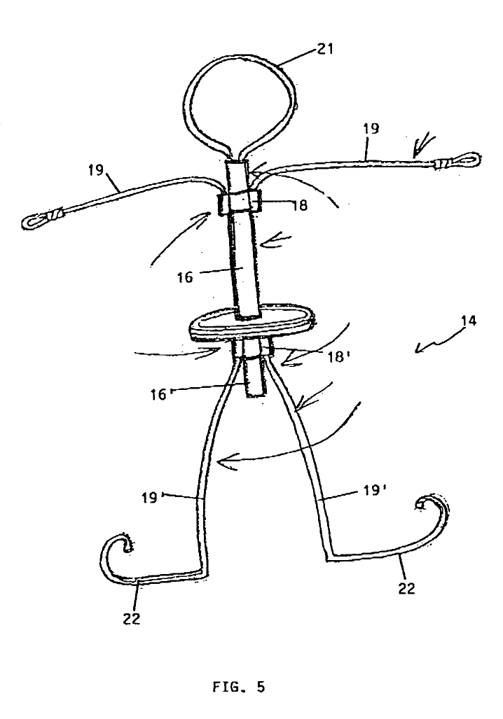

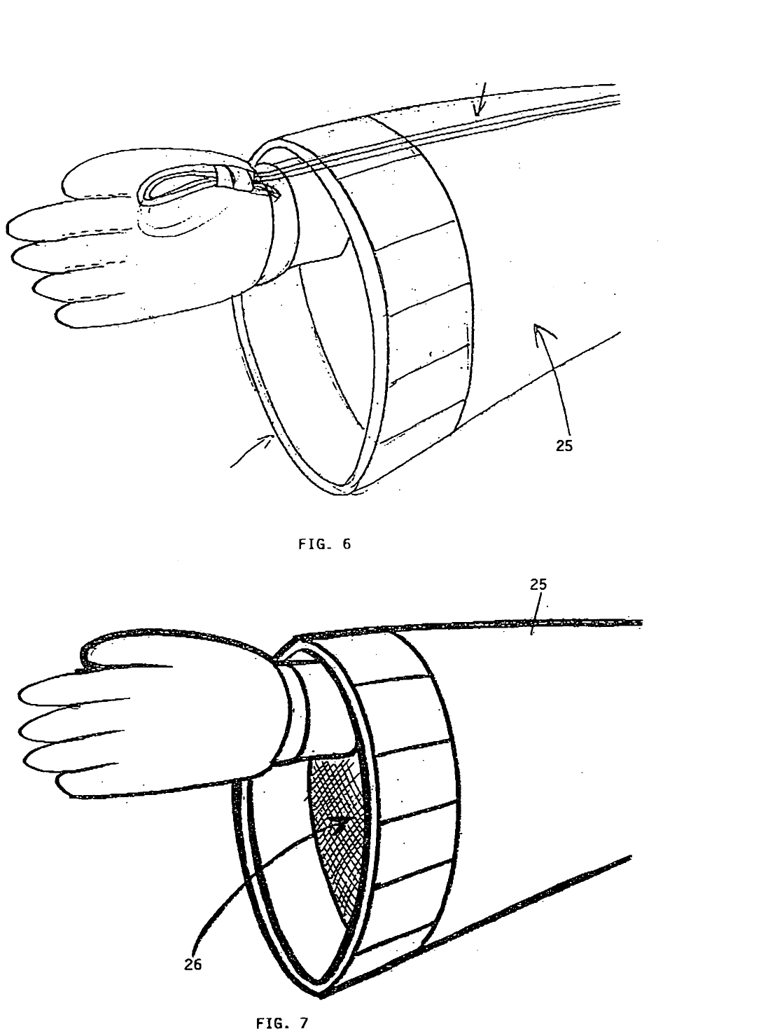

### DESCRIPTION OF THE PREFERRED EMBODIMENT

In the accompanying drawings there is depicted schematically a door-hanging ornament 10 suspended upon an open door 11 by a strap 12 in such manner that an upper body part 13 extends from one side of the door and a lower body part 14 extends from the other. In the example, the ornament takes the appearance of a friendly witch “flying through the door”. The strap might be made of any visually inconspicuous material such as a clear or substantially clear plastics ribbon.

The upper body part 13 comprises a support surface 15 in the form of a plastics disk. Extending upwardly from the centre of the disk 15 is a PVC plastics tube 16 forming a skeletal structure or backbone for the upper body part 13. A head 17 is attached to the tube 16.

There is an anchor member 18 fitted about the tube 16 serving to secure a pair of arm wires 19 thereto. The anchor member 18 might be formed of moulded plastics material or metal and includes a pair of diametrically opposed slots 20 into which proximal end portions of the wires 19 extend. A wire loop 21 extends from an upper end of the tube 16 to define a head frame that is dressed by a face and hat.

The lower body part 14 also includes a support surface 15′ and extending therefrom a tube 16′ having an anchor 18′ thereon. Leg wires 19′ extend from the anchor member 18′ in the same manner as do the arm wires 19. The leg wires 19′ are each bent to provide foot feature 22 to be dressed by shoes 23.

A broom head 24 might extend from the bottom end of the tube 16′.

The arms and legs of the witch would include padding surrounding the wires 19 and 19′, whereas the upper and lower body portions would typically be hollow. The body would be covered by clothing including sleeves 25 and trouser legs or stockings. In order to prevent the padding from escaping through the sleeve openings, a wire mesh 26 is inserted.

The strap 12 would be secured at both extends to the respective bases 15 and 15′.

In use, the strap is simply passed over the upper edge of the door and the upper and lower body parts are aligned vertically by moving the strap back or forth as necessary.

It should be appreciated that modifications and alterations obvious to those skilled in the art are not to be considered as beyond the scope of the present invention. For example, the ornament can take any form such as a warlock, animal or anything else that might fancifully fly through a solid object.

1. A hanging ornament for attachment to an opening closure such as a hinged or sliding door or window, the closure having opposed faces, the ornament comprising:
an upper body part including a support surface for bearing against one face of the closure and including peripheral body features including a head extending therefrom,
a lower body part including a support surface for bearing against the other face of the closure and including peripheral body features including feet extending therefrom, wherein the support surfaces are of substantially the same shape and together define a severance across a torso of a body defined by both said body parts when aligned, and
a strap extending from the upper body part to the lower body part for passing over the closure to suspend the body parts at either side in a substantially aligned manner.

2. The ornament of claim 1, wherein the support surfaces of the upper and lower body parts are each provided by a base from which a respective skeletal structure extends internally of the body parts, and wherein the strap is attached to each base.

3. The ornament of claim 2, wherein the skeletal structure comprises plastics tubing extending from the respective bases.

4. The ornament of claim 3, further comprising wire extending from the plastics tubing into said peripheral features.

5. The ornament of claim 4, further comprising anchor members attached to the plastics tubing and from which the wire extends.

6. The ornament of claim 5, wherein the wire defines arms and legs of the respective body parts.

7. The ornament of claim 6, further comprising padding about the wire and clothing about the padding.

8. The ornament of claim 7, further comprising hands and feet at respective distal ends of the wire.

9. The ornament of claim 7, wherein the clothing of the upper body part comprises sleeves, and wherein the padding is retained within the sleeves by mesh retainers surrounding the wire nearby the hands.

10. The ornament of claim 5, wherein the upper and lower body parts together define a witch and further comprising a broom head attached to the plastics tubing of the lower body part.
